(19) United States
(12) Patent Application Publication
(10) Pub. No.: US 2011/0109193 A1
(43) Pub. Date: May 12, 2011

(54) Motor device

(75) Inventors: Chang Keun Jun, Siheung (KR); Dong Yeon Shin, Suwon (KR)

(73) Assignee: SAMSUNG ELECTRO-MECHANICS CO., LTD., Suwon (KR)

(21) Appl. No.: 12/923,535

(22) Filed: Sep. 27, 2010

(30) Foreign Application Priority Data
Nov. 9, 2009 (KR) 10-2009-0107601

(51) Int. Cl. H02K 1/22

(52) U.S. Cl. 310/268

(57) ABSTRACT

There is provided a motor device. The motor device includes a sleeve including an axial hole, a shaft inserted in the axial hole and rotatably installed thereto, a rotor case coupled with the shaft, rotating together with the shaft, and supporting a disc disposed thereupon, and a balancer including one or more races formed inside the rotor case and guiding a plurality of balls for correcting imbalance caused when the disc rotates.

### CROSS-REFERENCE TO RELATED APPLICATIONS

This application claims the priority of Korean Patent Application No. 10-2009-0107601 filed on Nov. 9, 2009, in the Korean Intellectual Property Office, the disclosure of which is incorporated herein by reference.

### BACKGROUND OF THE INVENTION

1. Field of the Invention

The present invention relates to a motor device, and more particularly, to a motor device capable of achieving a reduction in the thickness thereof and performing an auto balancing function in rotating a shaft.

2. Description of the Related Art

In general, a spindle motor installed inside an optical disc drive serves to rotate a disc such that an optical pickup mechanism can read data stored on the disc.

Optical disc drives are currently required to be slimmer, lighter and smaller than their predecessors. Notably, in the case of an ultra slim motor used for laptop computers or the like, a magnetic circuit for driving the motor is also reduced in size. For this reason, such a motor is being designed in various ways in order to generate sufficient torque, while achieving stable rotation of a disc.

A motor device, according to the related art, includes a holder mounted on a shaft, and a separately produced case mounted on the holder. Since the motor device, according to the related art, is assembled using all of the above-described components, the respective thicknesses of the components hinders a reduction in the overall thickness thereof. Furthermore, a typical motor device, intended as a slim type, does not include a structure for automatically maintaining balance (i.e., auto balancing) at the time of rotation.

Therefore, a motor device, capable of achieving a reduction in overall thickness while being equipped with an auto balancing function, is in demand.

### SUMMARY OF THE INVENTION

An aspect of the present invention provides a motor device having a small thickness and equipped with an auto balancing function.

According to an aspect of the present invention, there is provided a motor device including: a sleeve including an axial hole; a shaft inserted into the axial hole and rotatably installed therein; a rotor case coupled with the shaft, rotating together with the shaft, and supporting a disc disposed thereupon; and a balancer including one or more races formed inside the rotor case and guiding a plurality of balls for correcting imbalance caused when the disc rotates.

The balancer may include a partition wall integrally formed between the races.

The balancer may include a positioning portion formed separately and adhered to an inner surface of the rotor case.

The balancer may include three races formed side by side on an inner surface of the rotor case.

The rotor case may be formed such that a surface thereof adjacent to the disc being received thereupon is disposed horizontally.

The rotor case may include a buffer member mounted on a top surface of the rotor case and contacting a bottom surface of the disc.

The motor device may further include a chuck housing mounted on the rotor case and fixing the disc.

The chuck housing may include a fixing chip fixing a location of the disc being received therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a motor device according to an exemplary embodiment of the present invention;

FIG. 2 is a plan view illustrating a balancer for a motor device according to the exemplary embodiment of the present invention;

FIGS. 3 and 4 are cross-sectional views illustrating a motor device according to another exemplary embodiment of the present invention; and

FIGS. 5 and 6 are cross-sectional views illustrating a motor device according to another exemplary embodiment of the present invention.

### DETAILED DESCRIPTION OF THE PREFERRED EMBODIMENT

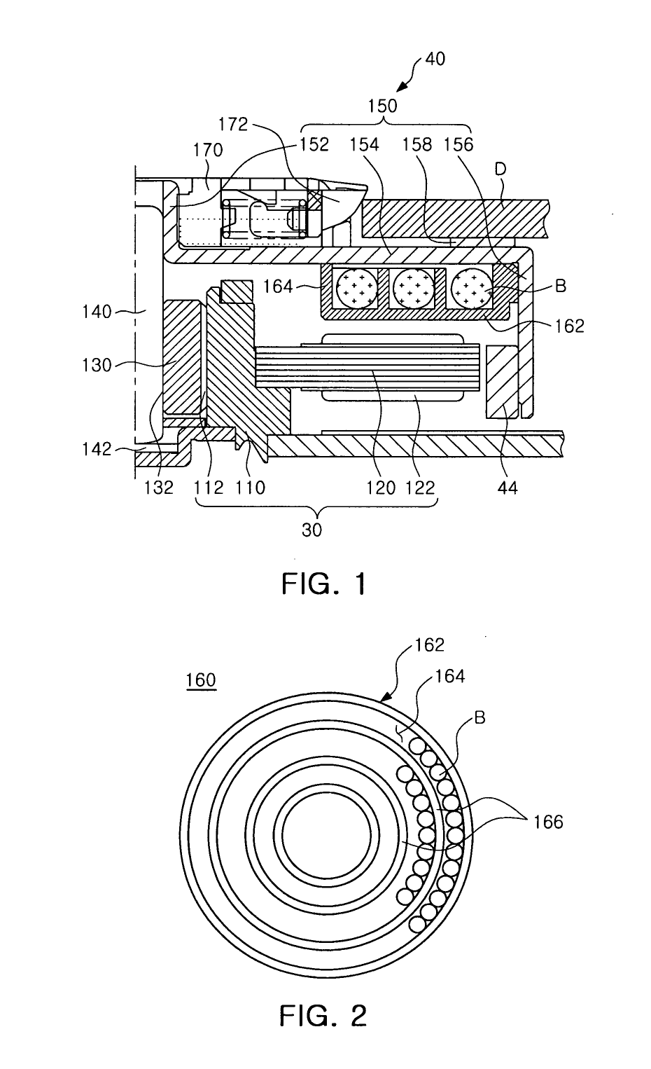

A motor device according to the present invention will be described in more detail with reference to FIGS. 1 through 6. Exemplary embodiments of the present invention will now be described in detail with reference to the accompanying drawings.

The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

The same or equivalent elements are referred to as the same reference numerals throughout the specification.

FIG. 1 is a cross-sectional view illustrating a motor device according to an exemplary embodiment of the present invention.

Referring to FIGS. 1 and 2, a motor device may include a sleeve 130, a shaft 140, a rotor case 150 and a balancer 160.

As shown in FIG. 1, the sleeve 130 may be assembled by forcibly inserting its lower body portion into a receiving hole 112 of a base 110. In this case, the sleeve 130 may refer to a rotation support member that corresponds to a rotor 40 at a predetermined interval therebetween to thereby provide a slide way therebetween.

The sleeve 130 may have an axial hole 132 for coupling with the shaft 140. A plurality of radial dynamic-pressure recesses may be formed in the inner surface of the axial hole 132.

The shaft 140 may be inserted into the axial hole 132 of the sleeve 130 and rotated. The rotor case 150 is mounted on the top surface of the shaft 140.

The shaft 140 may be elongated in the direction of a rotation axis. A thrust plate 142 is provided on the bottom of the shaft 140 to thereby reduce friction with the shaft 140, occurring at the time of rotation.

The rotor case 150 may include a hub 152 extending from the top end of the shaft 140 along the side surface thereof, a receiving portion 154 integrated with the hub 152 and receiving a disc D, and a vertical portion 156 extending perpendicularly from the receiving portion 154 in a downward direction.

In this case, the receiving portion 154, the top surface of the rotor case 150, may be formed horizontally so as to prevent the disc D from being inclined when placed thereupon. A buffer portion 158, contacting the bottom of the disc D, may be formed on the receiving portion 154. The buffer portion 158 may be formed of rubber.

Accordingly, the motor device, according to this exemplary embodiment, includes the rotor case 150 coupled with the shaft 140, rotated together with the shaft 140 and supporting the disk disposed thereupon. This significantly reduces the thickness of the motor device, as compared to a structure including a holder assembled with a shaft and mounted to the holder.

FIG. 2 is a plan view illustrating a balancer for the motor device according to the exemplary embodiment of the present invention.

Referring to FIG. 2, the balancer 160 may include a positioning portion 162, which may be mounted on the inner surface of the rotor case 150. A plurality of races 164 for guiding balls B may be formed inside the positioning portion 162.

In this case, the balls B serve to correct imbalance when the disc D rotates.

The operation thereof will now be described in detail. To operate a spindle motor, external power is applied to a coil 122. An electromagnetic force is generated between a magnet 44 and the coil 122 by the external power applied to the coil, so that the shaft 140 and the rotor case 150 are rotated together.

At this time, the motor is undesirably vibrated due to the eccentricity of the rotor case 150 and the eccentricity of a disc mounted on the rotor case 150. In order to compensate for centrifugal force caused by the eccentricity of the motor device, the balls B move along a circumference having a predetermined radius and are then placed at a location for compensating this eccentricity.

Thus, a balancing operation for canceling the eccentricity of the motor device is carried out by placing the balls B at a location allowing for the cancellation of the eccentricity of the motor device.

According to this exemplary embodiment, three races are formed inside the positioning portion 162, and partition walls 166 are formed to define the respective races.

Here, the positioning portion 162 may be adhered to the inner surface of the rotor case 150 by the medium of an adhesive.

The motor device, according to this exemplary embodiment, includes the balancer 160 formed inside the rotor case 150 and including the races for guiding the plurality of balls B for correcting imbalance when the disc rotates. Thus, the motor device may be equipped with the function of automatically adjusting balance (i.e., an auto balancing function) when the motor rotates.

Furthermore, according to this exemplary embodiment of the present invention, the balancer 160 can be formed by simply being adhered to the inner surface of the rotor case 150, so that the structure thereof can be easily realized. Since the balancer 160 includes the races, each receiving the plurality of balls B, the number of balls B can be adjusted according to a desired degree of balance.

Hereinafter, the construction illustrated in FIG. 1 will now be described in more detail.

The base 110 is provided with a substrate printed with pattern circuits, and includes a receiving hole 112 therein. The sleeve 130 is mounted in the receiving hole 112 by being forcibly inserted therein.

In this case, the base 110 may refer to a winding coil 122, generating an electromagnetic force of a predetermined magnitude when power is applied thereto, and a stator 30 configured as a fixed structure including a plurality of cores 120 around which the winding coil 122 is wound in a radial direction.

Also, the rotor 40 is a rotating structure that is provided rotatably with respect to the stator 30. The rotor 40 may include the rotor case 150 having a cup shape. Here, the magnet 44, having a ring shape and facing the cores 120 at a predetermined interval, is provided on the inner circumferential surface of the rotor case 150.

In this case, the magnet 44 is provided as a permanent magnet in which North and South poles are alternately magnetized to thereby generate a magnetic force of a predetermined intensity.

A chuck housing 170 is mounted on the rotor case 150 and may include an opening providing a receiving space in which a fixing chip 172 is received and exposed to the outside. Therefore, the fixing chip 172 may be mounted in the opening so as to be exposed to the outside, and a spring member, coupled with the fixing chip 172, may be inserted into the fixing chip 172.

When the disc D is mounted on the rotor case 150, contact occurs between the disc D and the fixing chip 172, and this contact elastically moves the fixing chip 172 in an inward direction. Once the disc D is mounted thereon, the fixing chip 172 is moved back to its initial location due to the spring member to thereby fix the disc D. In such a manner, the chuck housing 170 serves to prevent the disc D from slipping off the rotor case 150 while rotating.

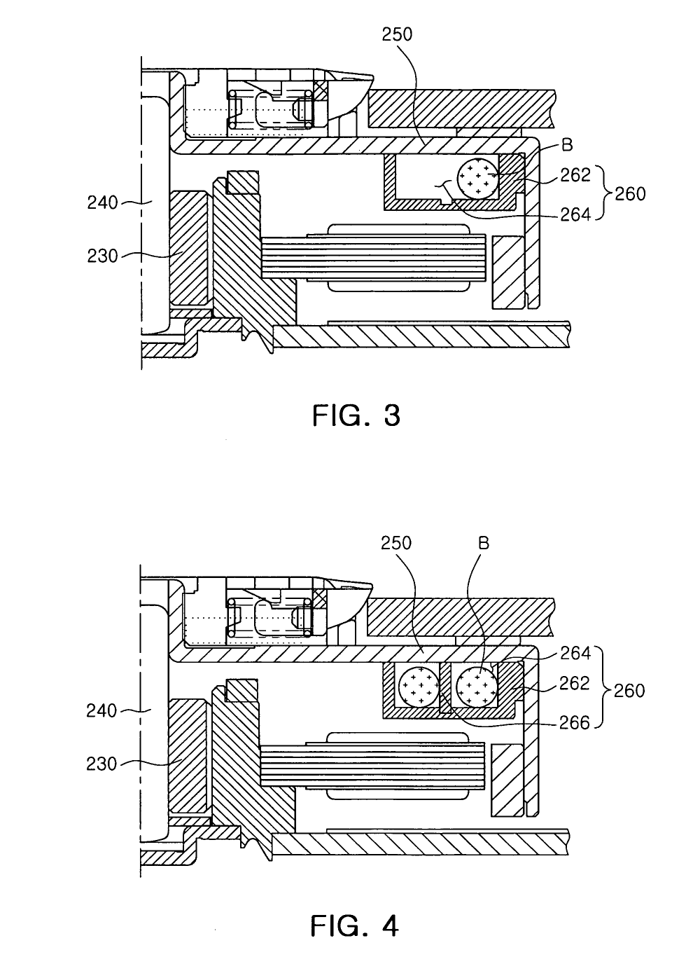

FIGS. 3 and 4 are cross-sectional views illustrating a motor device according to another exemplary embodiment of the present invention.

Referring to FIGS. 3 and 4, the motor device may include a sleeve 230, a shaft 240, a rotor case 250 and a balancer 260.

According to this exemplary embodiment, the sleeve 230, the shaft 240 and the rotor case 250 have substantially the same construction as those of the previous embodiment. Thus, a detailed description thereof may be omitted.

The balancer 260 may include a positioning portion 262 that may be mounted on the inner surface of the rotor case 250. A race 264 for guiding a ball B may be formed inside the positioning portion 262.

According to this exemplary embodiment, two races 264 may be formed in the positioning portion 262 by using a partition wall 266 that is separately formed to define the respective races 264.

Accordingly, a single ball B may be mounted inside the positioning portion 262. When another ball B is added, the separately formed partition wall 266 may be assembled thereto to form the races 264.

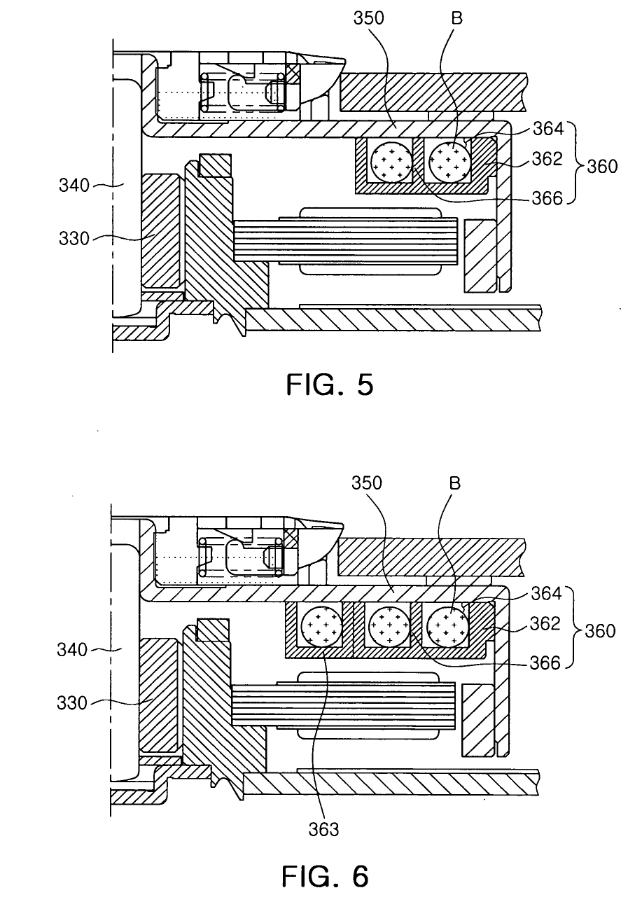

FIGS. 5 and 6 are cross-sectional views illustrating a motor device according to another exemplary embodiment of the present invention.

Referring to FIGS. 5 and 6, the motor device may include a sleeve 330, a shaft 340, a rotor case 350 and a balancer 360.

According to this exemplary embodiment, the sleeve 330, the shaft 340 and the rotor case 350 have substantially the same construction as those in the previous embodiment. Thus, a detailed description thereof may be omitted.

The balancer 360 may include a positioning portion 362 that may be mounted on the inner surface of the rotor case 350. A plurality of races 364 for guiding balls B may be formed inside the positioning portion 362.

According to this exemplary embodiment, two races 364 are formed inside the positioning portion 362, and a partition wall 366 is separately formed in order to define the respective races 364.

When there is a need for adjusting the number of balls B according to a desired degree of balance, a separate auxiliary positioning portion 366, including a single ball therein, may be adhered to the sidewall of the positioning portion 363.

Accordingly, the motor device, according to this exemplary embodiment, includes the auxiliary positioning portion 363 and the positioning portion 362 formed on the inner surface of the rotor case 350 and including the races 364 that guide the plurality of balls B for correcting imbalance when a disc rotates. Thus, the motor device may be equipped with an auto balancing function when a motor rotates.

As set forth above, according to exemplary embodiments of the invention, a motor device includes a rotor case coupled to a shaft, rotating together with a shaft and supporting a disc mounted thereupon, thereby achieving a reduction in its thickness as compared to a structure in which a holder mounted on a shaft is assembled with a case mounted on the holder.

In addition, the motor device, according to exemplary embodiments of the present invention, includes a balancer installed inside a rotor case and including races for guiding a plurality of balls correcting imbalance when the disc rotates. Accordingly, the motor device can be equipped with the function of automatically controlling balance when a motor rotates.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor device comprising:
a sleeve including an axial hole;
a shaft inserted into the axial hole and rotatably installed therein;
a rotor case coupled with the shaft, rotating together with the shaft, and supporting a disc disposed thereupon; and
a balancer including one or more races formed inside the rotor case and guiding a plurality of balls for correcting imbalance caused when the disc rotates.

2. The motor device of claim 1, wherein the balancer includes a partition wall integrally formed between the races.

3. The motor device of claim 1, wherein the balancer includes a positioning portion formed separately and adhered to an inner surface of the rotor case.

4. The motor device of claim 1, wherein the balancer includes three races formed side by side on an inner surface of the rotor case.

5. The motor device of claim 1, wherein the rotor case is formed such that a surface thereof adjacent to the disc being received thereupon is disposed horizontally.

6. The motor device of claim 1, wherein the rotor case includes a buffer member mounted on a top surface of the rotor case and contacting a bottom surface of the disc.

7. The motor device of claim 1, further comprising a chuck housing mounted on the rotor case and fixing the disc.

8. The motor device of claim 7, wherein the chuck housing includes a fixing chip fixing a location of the disc being received.
